(19) United States
(12) Patent Application Publication
(10) Pub. No.: US 2006/0294472 A1
(43) Pub. Date: Dec. 28, 2006

(54) User interface with figures mapping to the keys, for allowing a user to select and control a portable electronic device

(75) Inventors: Chih-Chuan Cheng, Taipei (TW); Hong-Tien Wang, Taipei (TW); Wen-Sung Tsai, Taipei (TW); Tsai-Chung Wang, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Compal Electronics, Inc.

(21) Appl. No.: 11/320,880

(22) Filed: Dec. 30, 2005

(30) Foreign Application Priority Data
Jun. 27, 2005 (TW) 094121389

(51) Int. Cl. G06F 9/00

(52) U.S. Cl. 715/771; 715/864; 715/810

(57) ABSTRACT

The present invention relates to a user interface with figures mapping to the keys, for allowing a user to select and control a portable electronic device, the portable electronic device comprises a display device, and a plurality of hardware keys are disposed on the portable electronic device to form a key field; thereby, the display device will display a figure field with a plurality of figures when the portable electronic device is powered on, and the figures will be mapped to the hardware keys layer by layer, therefore, every function represented by the figures can be executed when the user presses its mapping hardware key. Furthermore, the present invention also provides a portable electronic device having a user interface with figures mapping to the keys.

### BACKGROUND OF THE INVENTION

1. Field of the Invention

The present invention relates to a user interface, and more particularly to a user interface having a single figure mapping to a single key for allowing a user to quickly execute a function corresponding to the figure to operate a portable electronic device having such user interface.

2. Description of the Related Art

The prior art portable electronic device such as Apple's iPod, Tatung's Elio, and Samsung's iRiver, and the user interface (UI) of these devices requires a user to select the desired function in a menu, and then enter into another menu to select the desired function, and so forth. Such method of selecting the desired function in the menus from layer to layer has the following shortcomings: 1. The procedure of selecting the function is complicated and thus causing inconvenient operations to users. 2. The design of the interface is not user-friendly. 3. The method is boring and not skillful enough.

In addition, Apple's iPod focuses on pull-down menus. Although the portable device having a touch-screen display device can play audio/video data by selecting the function, the portable device has to install some keys for inputting the instruction for running a game program, and these keys are not related to the playing of the audio/video data. Therefore, the present portable device still lacks the hardware keys to operate with the figures to control the function of playing audio/video data.

R.O.C. Pat. No. 259951 entitled “audio/video playing control box” (filed on Jun. 24, 2004 and published on Mar. 21, 2005) relates to an audio/video playing control box that comprises: a box having an audio/video equipment input port and an audio/video signal output port disposed at an appropriate position, and the two ports separately have a plurality of AV connectors for connecting a plurality of audio/video equipments and display devices; and a control circuit installed in the box and connected separately with the audio/video equipment input port and the audio/video signal output port; wherein the control circuit includes a microcontroller and a selector, and the input end of the selector is connected to the audio/video equipment input port, and the output end of the selector is connected to the audio/video signal port, and the control end is connected to the microcontroller. Such patent primarily relates to an audio/video playing control box for connecting a plurality of audio/video equipments and display devices. However, such patent does not come with hardware keys to operate with figures to control the function of playing audio/video data.

### SUMMARY OF THE INVENTION

The primary objective of the present invention is to provide a user interface with figures mapping to the keys and a portable device having such user interface that uses a single figure to map to a single key to simplify the selecting procedure and make the operation easy for operators.

Another objective of the present invention is to provide a user interface with figures mapping to the keys and a portable device having such user interface, such that a user just needs to follow the prompt of a corresponding figure to press a key to execute the function corresponding to the figure, and thus the design of the user interface is more friendly.

A further objective of the present invention is to provide a user interface with figures mapping to the keys and a portable device having such user interface that uses a single figure to operate with a key, and the figure in each layer is corresponsive to the key, and the figure in each later of the interface is corresponsive to the required executing function, so that the user can directly press the key corresponding to the figure regardless of the layers to execute the function indicated by the figure, and provide fresh and new experience.

To achieve the foregoing objectives, the present invention provides a user interface with figures mapping to the keys for allowing a user to control and select a portable device, and the user interface includes a plurality of layers of figure fields, and the portable device includes a display device and a key field comprised of a plurality of hardware keys, wherein each layer of figure fields has a plurality of figures, and each figure of each layer of the figure fields has an one-to-one mapping with the hardware key. After the portable device is powered on, one of the plurality of layers of figure fields is displayed on the display device, and one of the plurality of hardware keys is pressed to execute the function indicated by the figure and corresponding to the hardware key. After the function indicated by the figure is executed, the figure field in the plurality of layers of figure fields displayed on the display device is corresponsive to the executed function corresponding to the figure. Of course, each figure in the newly displayed figure field is also corresponsive to each of the hardware keys.

To achieve the foregoing objectives, the present invention provides a portable device with figures mapping to keys of a user interface, and the portable device comprises a display device and a plurality of hardware keys, wherein the plurality of hardware keys define a key field for users to control and select on the portable device. After the portable device is powered on, a figure field will be displayed on the display device. The figure field includes a plurality of figures, and each figure is corresponsive with each hardware key layer by layer. Each hardware key is pressed to execute the function indicated by each figure.

### BRIEF DESCRIPTION OF THE DRAWINGS

FIG. 1 is a schematic view of a user interface with figures mapping to keys and a portable device having such user interface according to a preferred embodiment of the present invention;

FIG. 2 is a schematic view of a display device showing a figure in next layer of a user interface when a hardware key of a Video figure is pressed according to the present invention;

FIG. 3 is a schematic view of a display device showing a figure in next layer of a user interface when a hardware key of a play figure is pressed according to the present invention;

FIG. 4 is a schematic view of a figure field of a user interface according to the present invention; and

FIG. 5 is a flow chart of a user interface operation of the present invention.

### DETAILED DESCRIPTION OF THE PREFERRED EMBODIMENTS

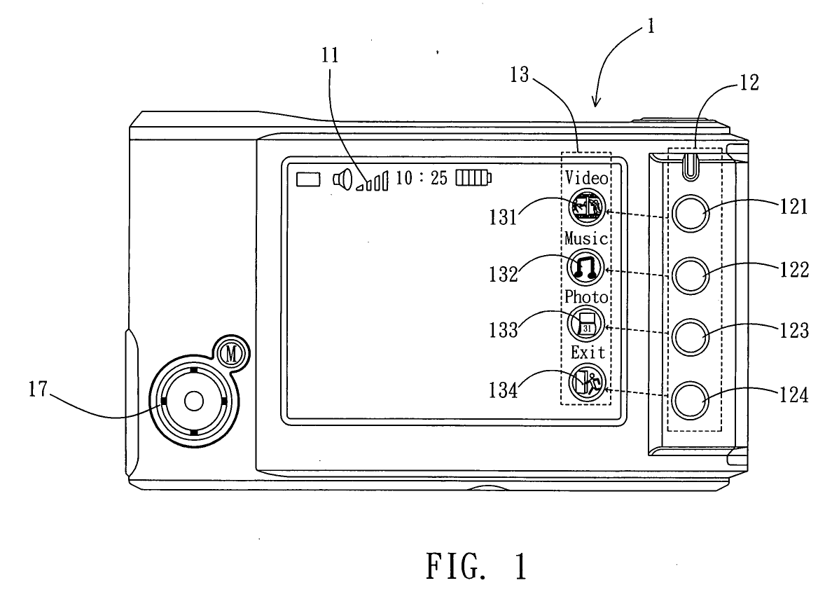

Referring to FIG. 1 for the schematic view of a user interface with figures mapping to keys and a portable device having such user interface according to a preferred embodiment of the present invention, a portable device 1 having such user interface, preferably a portable audio/video player having a camera function or a personal digital assistant (PDA), comprises a display device 11 and a key field 12.

The display device 11 including but not limited to a liquid crystal display (LCD) is provided for displaying data, and the key field 12 comprises a plurality of hardware keys 121, 122, 123, 124 for allowing a user to control and select the portable device 1. After the portable device 1 is powered on, a figure field 13 will be displayed on the display device 11, and the figure field 13 comprises a plurality of FIGS. 131, 132, 133, 134, wherein the FIG. 131 is a figure representing a “Video” function, the FIG. 132 is a figure representing a “Music” function, the FIG. 133 is a figure representing a “Photo” function, and the FIG. 134 is a figure representing an “Exit” function, and each FIG. 131, 132, 133, 134 of this layer is corresponding to each hardware key 121, 122, 123, 124, so that a user can press a hardware key 121, 122, 123, 124 to execute the function corresponding to each FIG. 121, 132, 133, 134.

The number of hardware keys 121, 122, 123, 124 of the key field 12 is equal to the number of FIGS. 131, 132, 133, 134 of the figure field 13 for carrying out the one-to-one mapping. Of course, an automatic hidden function can be designed for the figure field 13, so that the figure field 13 can be hidden automatically when the audio/video data is viewed to prevent interferences to the screen. Any one of the hardware keys 121, 122, 123, 124 is pressed to call out the figure field 13 if needed.

If a user wants to carry out a video related function, the user can press a corresponding hardware key 121 on the right side of a FIG. 31 to execute the video related function indicated by the FIG. 131. Similarly, if a user wants to carry out a music related function, the user can press a hardware key 122 corresponding to a FIG. 132 to execute the music related function indicated by the FIG. 132, and if a user wants to carry out a photo related function, the user can press a hardware key 123 corresponding to a FIG. 133 to execute the photo function indicated by the FIG. 133. If a user wants to return to the previous layer of the interface, the user can press a hardware key 124 corresponding to a FIG. 134 to execute the exit function indicated by the figure.

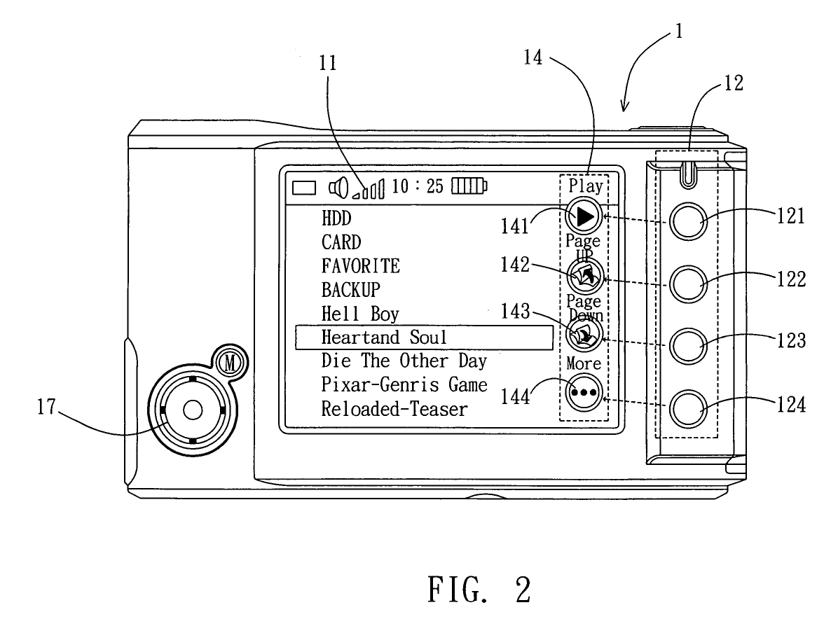

Referring to FIG. 2 for the schematic view of a display device 11 showing a figure in next layer of a user interface when a hardware key 121 of a Video figure 131 is pressed according to the present invention, the display device 11 will show a figure field 14 of next layer corresponding to the desired video data if the hardware key 121 of the user interface of a portable device 1 is pressed. The figure field 14 further comprises a Play FIG. 141, a Page Up FIG. 142, a Page Down FIG. 143 and a More FIG. 144. The Play FIG. 141 of this layer corresponds to the hardware key 121 of this layer, and the hardware key 121 is pressed to execute the Play FIG. 141 to carry out the function of playing video data. Similarly, the Page Up FIG. 142 of this layer corresponds to the hardware key 122 of this layer, and the hardware key 122 is pressed to carry out the function of browsing the previous page of video data; the Page Down FIG. 143 of this layer corresponds to the hardware key 123 of this layer, and the hardware key 123 is pressed to carry out the function of browsing the video data of the next page; the More FIG. 144 of this layer corresponds to the hardware key 124 of this layer, and the hardware key 124 is pressed to carry out more other functions. Therefore, the figure field 14 of this layer corresponds to the hardware key field 12 of this layer, and a user can use an arrow key 17 to select the desired playing video data, and the hardware key 121 corresponding to the Play FIG. 141 is pressed to play the selected video data.

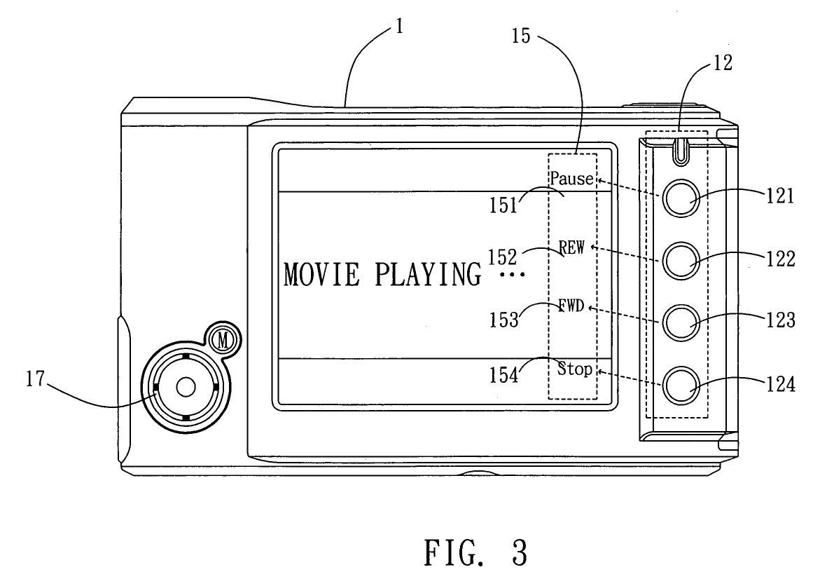

Referring to FIG. 3 for the schematic view of a display device 11 showing a figure in next layer of a user interface when a hardware key 121 of a Play FIG. 141 is pressed according to the present invention, the display device 11 will show a figure field 15 of a next layer corresponding to the video data as shown in FIG. 3 when the hardware key 121 corresponding to the Play FIG. 141 of the user interface of a portable device 1 is pressed. The figure field 15 further comprises a Pause FIG. 151, a forward (FWD) FIG. 152, a rewind (REW) figure 153, and a (Stop) FIG. 154. A Pause FIG. 151 of this layer corresponds to a hardware key 121, and the hardware key 121 is pressed to pause the function of playing the video data; a Forward FIG. 152 of this layer corresponds to a hardware key 122 of this layer, and the hardware key 122 is pressed to carry out the function of forwarding the video data; a backward FIG. 153 of this layer corresponds to a hardware key 123 of this layer, and the hardware key 123 is pressed to carry out the function of rewinding the video data; and a Stop FIG. 154 of this layer corresponds to a hardware key 124 of this layer, and the hardware key 124 is pressed to stop the function of playing the video data. Therefore, the figure field 15 of this layer corresponds to each hardware key 121, 122, 123, 124, and a user can use each hardware key 121, 122, 123, 124 to select the desired Pause function, forward (FWD), rewind (REW) or stop function.

In summation of the description above, the user interface of the present invention uses layers of figures to correspond to the fixed hardware keys 121, 122, 123, 124 and execute the function indicated by the corresponding hardware key by pressing the hardware key. Regardless of the layer of the figure, a user just needs to select the desired figure and press the corresponding hardware key for executing the function indicated by the figure.

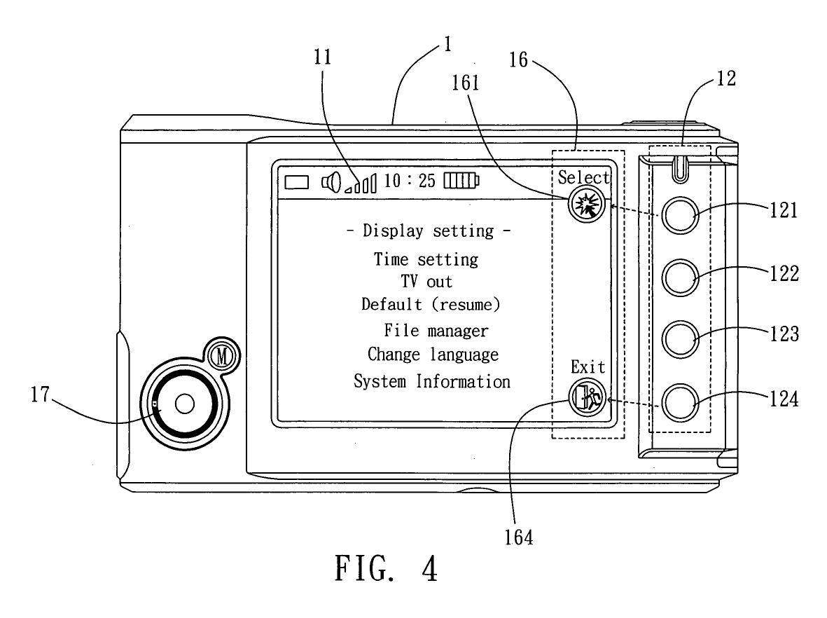

Referring to FIG. 4 for the schematic view of a figure field of a user interface according to the present invention, the four figures in the figure field 16 will not have all of their functions, if the user interface of the portable device 1 does not require so many functions, However, the FIGS. 161, 164 are still adopted to have the operating method corresponding to the hardware key 121, 124, wherein the FIG. 161 corresponds to the hardware key 121, and the FIG. 164 corresponds to the hardware key 124.

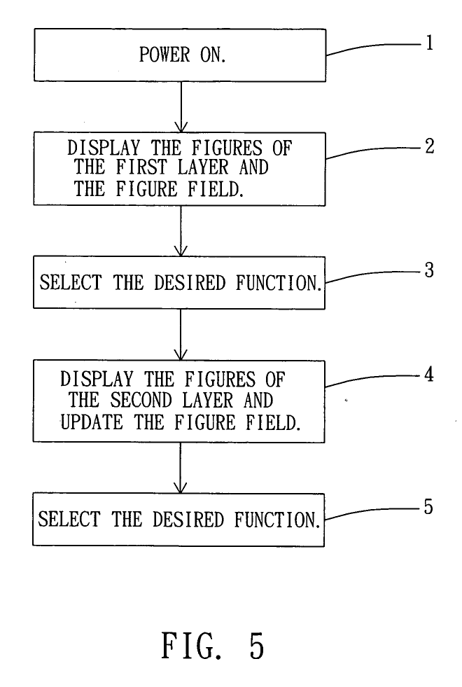

Referring FIGS. 1 to 5, FIG. 5 shows a flow chart of a user interface operation of the present invention. In the figure, the portable device 1 of the present invention is operated according to the following steps: (Step 1) Power on the portable device 1. (Step 2) The display device 11 of the portable device 1 displays the user interface and the figure field 13, and the figure field 13 includes a plurality of FIGS. 131, 132, 133, 134 having an one-to-one mapping with a plurality of hardware keys 121, 122, 123, 124 layer by layer. (Step 3) A user selects the desired function and presses the FIG. 131, 132, 133, 134 corresponding to the hardware key 121, 122, 123, 124 to execute the function indicated by the figure. (Step 4) The display device 11 displays a second layer interface and shows a new figure field 14 and each figure 141, 142, 143, 144 and updates the functions of each FIG. 141, 142, 143, 144 corresponding to the desired operating function of the second layer, and each FIG. 141, 142, 143, 144 also has an one-to-one mapping separately with the plurality of hardware keys 121, 122, 123, 124. (Step 5) The user selects the desired function in the second layer of interface and presses the hardware key 121, 122, 123, 124 having the function corresponding to the FIG. 141, 142, 143, 144 to execute the function indicated by the FIG. 141, 142, 143, 144. Therefore, the user can use the simple layer-by-layer mapping of the figure field 13, 14, 15, 16 having a plurality of figures and a single key field 12 to operate the portable device 1 regardless of the layer of the user interface, and thus providing a quick and convenient operation for users.

In the present invention, the portable device includes a plurality of hardware keys to define a key field. After the portable device is powered on, the display device shows a figure field, and the figure field includes a plurality of figures, and each figure corresponds to each hardware key layer by layer. The hardware key is pressed to execute the function indicated by the figure. Therefore, the present invention surely can overcome the shortcomings of the prior art portable video player or personal digital assistant.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A user interface with figures mapping to keys for allowing a user to control and select a portable device, said user interface having a plurality of figure fields, said portable device having a display device and a key field comprised of a plurality of hardware keys, wherein said each figure field of each layer includes a plurality of figures, and said each figure of said figure field of each layer has an one-to-one mapping with said each hardware key, such that after said portable device is powered on, said display device display shows one of said plurality of layers of figure fields, and one of said plurality of hardware keys is pressed to execute a corresponding function indicated by said figure, and after said function indicated by said figure is executed, said display device shows a figure field corresponding to a function indicated by said figure in said plurality of layers of figure field.

2. The user interface with figures mapping to keys of claim 1, wherein said portable device is a portable video player or a personal digital assistant. (PDA).

3. The user interface with figures mapping to keys of claim 1, wherein said figure field includes an automatic hidden function, such that when said video data is viewed, said video data is hidden to prevent interferences to a screen, and said figure field will show if any one of said hardware keys is pressed.

4. The user interface with figures mapping to keys of claim 1, wherein said figure field further comprises a Play figure, a Music figure, a Photo figure, and an Exit figure.

5. The user interface with figures mapping to keys of claim 1, wherein if said Play figure is executed, said display device shows a first figure field corresponding a function required for playing said video data.

6. The user interface with figures mapping to keys of claim 5, wherein said first figure field further comprises a Play figure, a Page Up figure, a Page Down figure, and a More figure.

7. The user interface with figures mapping to keys of claim 6, wherein if said Play figure is executed, said display device shows said video data and updates a second figure field of a corresponding function.

8. The user interface with figures mapping to keys of claim 7, wherein said figure field further comprises a Pause figure, a Forward figure, a Review figure, and a Stop figure.

9. The user interface with figures mapping to keys of claim 1, wherein said display device is a crystal liquid display device.
